(19) United States
(12) Patent Application Publication
(10) Pub. No.: US 2021/0331983 A1
(43) Pub. Date: Oct. 28, 2021

(54) COATING FOR PROTECTING EBC AND CMC LAYERS AND THERMAL SPRAY COATING METHOD THEREOF

(71) Applicant: OERLIKON METCO (US) INC., Westbury, NY (US)

(72) Inventors: Dianying CHEN, Westbury, NY (US); Chris DAMBRA, Greenlawn, NY (US)

(73) Assignee: OERLIKON METCO (US) INC., Westbury, NY (US)

(21) Appl. No.: 17/414,190

(22) PCT Filed: Dec. 17, 2019
(86) PCT No.: PCT/US2019/066943

§ 371 Date: Jun. 15, 2021

Related U.S. Application Data
(60) Provisional application No. 62/781,324, filed on Dec. 18, 2018.

(51) Int. Cl. C04B 41/45; C04B 41/89; C04B 35/488

(52) U.S. Cl. CPC C04B 41/4527; C04B 41/89; C04B 2235/3248; C04B 2235/3222; C04B 2235/3224; C04B 35/488

(57) ABSTRACT

A multi-layer coating arrangement includes an environmental barrier coating (EBC) over a substrate; and at least one dense vertically cracked (DVC) coating layer over the EBC. The at least one DVC layer is resistant to erosion, water vapor corrosion and to calcium-magnesium-aluminum-silicate (CMAS).

### PRIORITY TO RELATED APPLICATION

This application is a U.S. National Stage of International Application No. PCT/US2019/066943 filed Dec. 17, 2019 and claims priority to U.S. Provisional Application No. 62/781,324, filed on Dec. 18, 2018, the disclosures of which are incorporated herein by reference in their entireties.

### BACKGROUND

### 1. Field of the Disclosure

Example embodiments relate to multilayer ceramic coatings that are resistant to erosion, water vapor corrosion and to Calcium-Magnesium-Aluminum-Silicate (CMAS), which protect environmental barrier coatings (EBC) that may overly ceramic matrix composite (CMC) substrates. A coating method of the CMAS-resistant multilayer ceramic is also disclosed.

### 2. Background Information

EBCs are advantageous for the protection of CMCs from oxidation and other water vapor attacks. In high temperature gas turbine engine environments (e.g., up to 1600° C.), EBCs may be subject to erosion, foreign object damage, water vapor corrosion, and CMAS attack. Rare-earth silicates (RE₂SiO₅ or RE₂Si₂O₇) are example of EBC material candidates. However, the Rare-earth silicates may experience recess under high temperature, high pressure steam environment due to reaction with water vapor. In addition, Rare-earth silicates systems are not capable of protecting EBCs from CMAS attack. Dust penetration by CMAS, and the chemical reactions between the CMAS and EBC can cause the EBC to spall, i.e., break down in small flakes, which may result in the loss of protection for the underlying CMC layers or substrate.

Yttrium-stabilized zirconia (YSZ) thermal barrier coatings have been used in the gas turbine engines and have exhibited good water vapor corrosion resistance in combustion environment. However, YSZ coatings and layers generally have a larger coefficient of thermal expansion (CTE), e.g., in the range of ˜10×10⁻⁶/° C., than lower-CTE CMC layers, which typically have a CTE of ˜4×10⁻⁶/° C. Therefore, strain tolerant coating microstructure is advantageous in applying a YSZ-based coating over EBCs/CMCs.

### SUMMARY

In view of the above problems and disadvantages, there is a need to improve the erosion, water vapor corrosion, and CMAS-resistance of EBC/CMC coating systems. Example embodiments include a ceramic topcoat that is resistant to erosion, water vapor corrosion, and to CMAS for the protection of the EBC/CMC coating system. A coating method is also disclosed.

Example embodiments include a multi-layer coating arrangement that includes an EBC over a substrate; and at least one dense vertically cracked (DVC) coating layer over the EBC, the at least one DVC layer being resistant to erosion, water vapor corrosion, and to CMAS.

The present disclosure, through one or more of its various aspects, embodiments, and/or specific features or sub-components, provides, inter alia, multilayer coatings which include DVC topcoats that are resistant to erosion, water vapor corrosion, and to CMAS, the multilayer coatings being coated onto an EBC. In example embodiments, the multilayer coatings do not require intermediate layers, such as, e.g., one or more porous vertically cracked (PVC) intermediate coatings between the DVC topcoats and the EBC, to mitigate the CTE difference between the DVC topcoats and the EBC. In other example embodiments, due at least in part to the presence of the highly strain tolerant DVC layer, no intermediate PVC coating is needed to mitigate the CTE difference between the DVC topcoat and the EBC.

Example embodiments include a coating system wherein one or more EBC layers are first applied onto a CMC substrate. Subsequently, one or more dense vertically cracked (DVC) coating layers that are resistant to erosion, water vapor corrosion, and to CMAS are applied or deposited as a top layer on the one or more EBC layers.

In example embodiments, the porosity of the DVC layer may be less than 5%, and the cracks within the DVC layer may extend either partially through the thickness of the DVC layer, i.e., through less than 50% of the thickness, or through about 50% of the thickness of the DVC layer, and may even extend through an entire thickness of the DVC layer. In embodiments, the cracks may be substantially vertical cracks and may range in density between 20 and 200 cracks per inch.

According to example embodiments, the useful life of the EBC/CMC component may be extended by the existence of the DVC top layer, which extends and improves the working life of a machine or engine that includes the EBC/CMC component.

In example embodiments, a strain-tolerant DVC coating top layer protects the EBC/CMC combination underneath. The DVC layer may be composed of, or include, ZrO₂ or HfO₂, either of which may be stabilized with a rare earth oxide (RE₂O₃), and mixed with a CMAS-resistant chemical composition. As used herein, a CMAS-resistant composition includes a chemical composition that can react with the CMAS dust and form a crystalline phase that prevents further penetration of the CMAS into the underlying coating, i.e., prevents penetration of CMAS into the DVC coating layer. A CMAS-resistant composition also includes a chemical composition that can increase the CMAS melting temperature after reacting with CMAS.

Advantages of the example embodiments include a RE-stabilized ZrO₂ or RE-stabilized HfO₂ mixed with a CMAS-resistant composition to improve the erosion- and CMAS-resistance of the EBC/CMC system.

Example embodiments of the DVC top layer, with the DVC being resistant to erosion, water vapor corrosion, and to CMAS, include the following (with exemplary rare earth oxides including Yttrium Oxide, Lanthanum Oxide, Cerium Oxide, Praseodymium Oxide, Neodymium Oxide, Samarium Oxide, Europium Oxide, Gadolinium Oxide, Terbium Oxide, Dysprosium Oxide, Holmium Oxide, Erbium Oxide, Ytterbium Oxide, Lutetium Oxide, Scandium Oxide, Thulium Oxide):

RE-stabilized ZrO₂ or RE-stabilized HfO₂

RE-stabilized ZrO₂ or RE-stabilized HfO₂ mixture with Rare earth oxides; or

RE-stabilized ZrO₂ or RE-stabilized HfO₂ mixture with Rare earth Silicate; or

RE-stabilized ZrO₂ or RE-stabilized HfO₂ mixture with Rare earth Aluminate; or

RE-stabilized ZrO₂ or RE-stabilized HfO₂ mixture with Rare earth Aluminate Silicate; or

RE-stabilized ZrO₂ or RE-stabilized HfO₂ mixture with alkaline oxides; or

RE-stabilized ZrO₂ or RE-stabilized HfO₂ mixture with Gadolinium Zirconate; or

Rare earth silicates or

Any combination of the above.

In example embodiments, although a DVC top layer is described herein, the top layer may include a plurality of DVC layers.

In example embodiments, the DVC top layer(s) may have a CTE of ˜10×10⁻⁶/° C., as well as a thickness of between 2 mils (0.002 inches) and 40 mils (0.040 inches). As used herein, a mil is equal to 0.001 inches. The DVC top layer(s) may be applied via a number of methods such as, e.g., atmospheric plasma spraying (APS), plasma spray physical vapor deposition (PS-PVD), or suspension plasma spray (SPS).

In example embodiments, the EBC layer(s) may have a CTE of 3.5×10⁻⁶-7×10⁻⁶/° C., as well as a thickness of between 1 mils and 40 mils. This layer or coating may be applied via a number of methods such as, e.g., atmospheric plasma spraying (APS), plasma spray physical vapor deposition (PS-PVD), or suspension plasma spray (SPS).

In example embodiments, one or more bond coating layers may be provided between the EBC layer(s) and the underlying CMC, the bond coating layer(s) being configured to improve bonding between the EBC layer(s) and the CMC. In example embodiments, the bond coating layer(s) may be Si, Si—HfO₂, Silicides and/or Si-RE, and may have a CTE of 3.5×10⁻⁶-6×10⁻⁶/° C., as well as a thickness between 0 mils and 10 mils. This layer or coating may be applied via a number of methods such as, e.g., atmospheric plasma spraying (APS), plasma spray physical vapor deposition (PS-PVD), or suspension plasma spray (SPS).

In example embodiments, the CMC substrate may have a CTE of ˜4.5×10⁻⁶-5.5×10⁻⁶/° C., as well as a thickness greater than 40 mils and up to about 100 mils. The substrate may be an SiC or Si₃N₄ material.

In example embodiments, at least one DVC coating layer may include RE-stabilized ZrO₂ or RE-stabilized HfO₂, or RE-stabilized ZrO₂ or RE-stabilized HfO₂ mixed with one or more rare earth oxides. In other example embodiments, the at least one DVC coating layer may include RE-stabilized ZrO₂ or RE-stabilized HfO₂ mixed with rare earth silicate. In further example embodiments, at least one DVC coating layer may include RE-stabilized ZrO₂ or RE-stabilized HfO₂ mixed with rare earth aluminate. In still further example embodiments, at least one DVC coating layer may include RE-stabilized ZrO₂ or RE-stabilized HfO₂ mixed with rare earth aluminate or silicate. In other example embodiments, at least one DVC coating layer may include RE-stabilized ZrO₂ or RE-stabilized HfO₂ mixed with alkaline oxide. In further example embodiments, at least one DVC coating layer may include RE-stabilized ZrO₂ or RE-stabilized HfO₂ mixed with gadolinium zirconate. In further example embodiments, at least one DVC coating layer may include Rare earth silicates. In still further example embodiments, at least one DVC coating layer may include a mixture of one or more compositions described above.

In example embodiments, at least one DVC coating layer may include full thickness vertical cracks.

Example embodiments of the invention include a DVC coating bonded directly to an EBC layer, and the EBC layer is bonded directly to a CMC substrate.

Example embodiments of the invention include a method of plasma spraying an erosion, water vapor corrosion-, and CMAS-resistant coating on an EBC coated substrate, the method including depositing a DVC coating material over the EBCs/CMCs.

In example embodiments, the EBC coated substrate may include at least one bond coating layer arranged between the EBC layer and the substrate. The plasma spraying may include one of atmospheric plasma spraying (APS), physical vapor deposition (PS-PVD), or suspension plasma spray (SPS).

According to another aspect, the invention relates to an erosion-, water vapor corrosion-, and CMAS-resistant coating arranged on an EBC coated substrate, the coating comprising: a top layer of DVC erosion- and CMAS-resistant coating material deposited over the EBC coated substrate.

In an embodiment of the coating, it further comprises at least one bond coating layer between the EBC and the substrate.

In an embodiment of the coating, the substrate comprises a CMC.

In an embodiment of the coating, the at least one DVC erosion-, water vapor corrosion-, and CMAS-resistant coating layer comprises RE-stabilized ZrO₂ or RE-stabilized HfO₂ mixed with rare earth oxide.

In an embodiment of the coating, the at least one DVC erosion-, water vapor corrosion-, and CMAS-resistant coating layer comprises RE-stabilized ZrO₂ or RE-stabilized HfO₂ mixed with rare earth silicate.

In an embodiment of the coating, the at least one DVC erosion-, water vapor corrosion-, and CMAS-resistant coating layer comprises RE-stabilized ZrO₂ or RE-stabilized HfO₂ mixed with rare earth aluminate.

In an embodiment of the coating, the at least one DVC erosion-, water vapor corrosion-, and CMAS-resistant coating layer comprises RE-stabilized ZrO₂ or RE-stabilized HfO₂ mixed with rare earth aluminate or silicate.

In an embodiment of the coating, the at least one DVC erosion-, water vapor corrosion-, and CMAS-resistant coating layer comprises RE-stabilized ZrO₂ or RE-stabilized HfO₂ mixed with alkaline oxide.

In an embodiment of the coating, the at least one DVC erosion-, water vapor corrosion-, and CMAS-resistant coating layer comprises RE-stabilized ZrO₂ or RE-stabilized HfO₂ mixed with gadolinium zirconate.

In an embodiment of the coating, the at least one DVC erosion-, water vapor corrosion-, and CMAS-resistant coating layer comprises a mixture of two or more of: (i) RE-stabilized ZrO₂ or RE-stabilized HfO₂; (ii) RE-stabilized ZrO₂ or RE-stabilized HfO₂ mixed with rare earth oxide; (iii) RE-stabilized ZrO₂ or RE-stabilized HfO₂ mixed with rare earth silicate; (iv) RE-stabilized ZrO₂ or RE-stabilized HfO₂ mixed with rare earth aluminate; (v) RE-stabilized ZrO₂ or RE-stabilized HfO₂ mixed with rare earth aluminate or silicate; (vi) RE-stabilized ZrO₂ or RE-stabilized HfO₂ mixed with alkaline oxide; (vii) RE-stabilized ZrO₂ or RE-stabilized HfO₂ mixed with gadolinium zirconate; and (viii) Rare earth silicates.

In an embodiment of the coating, the top layer of DVC erosion-, water vapor corrosion-, and CMAS-resistant coating layer comprises full thickness vertical cracks.

According to another aspect, the invention relates to an erosion-, water vapor corrosion-, and CMAS-resistant ceramic coating arranged on a CMC substrate, comprising: (i) an EBC coating layer bonded to the substrate; and (ii) a DVC erosion-, water vapor corrosion-, and CMAS-resistant coating layer deposited directly on the EBC coating layer.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 schematically shows a multi-layer coating in accordance with example embodiments;

FIG. 2 shows a scanning electron microscope SEM) cross-section of an applied multi-layer coating in accordance with example embodiments;

FIG. 3 shows a cross-section of an applied multi-layer coating subjected to testing viewed via scanning electron microscope (SEM), in accordance with example embodiments;

FIG. 4 describes the coating system used in the coating layer of FIG. 3;

FIG. 5 shows the parameters used to spray the coating system of FIG. 4; and

FIG. 6 shows a cross-section of the applied multi-layer coating illustrated in FIG. 3 after the application of a 900 plus cycle test, in accordance with example embodiments.

### DETAILED DESCRIPTION

Through one or more of its various aspects, embodiments and/or specific features or sub-components of the present disclosure, are intended to bring out one or more of the advantages as specifically described above and noted below.

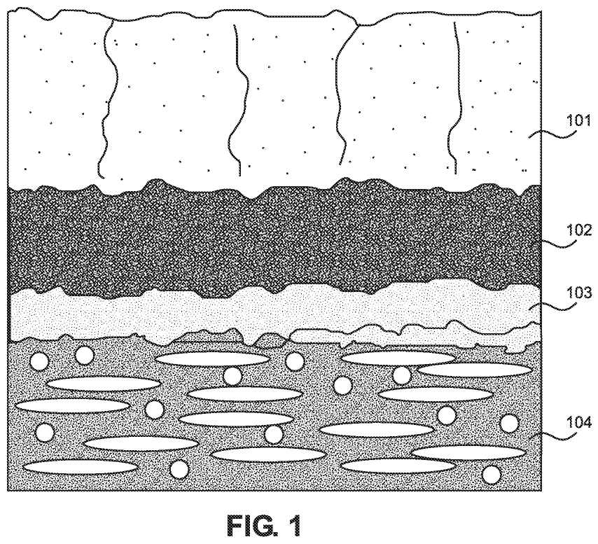

FIG. 1 schematically shows a multi-layer coating in accordance with example embodiments. FIG. 1 schematically illustrates a multi-layer coating arrangement arranged 101/102 on a substrate 104 such as, e.g., a CMC substrate 104. As illustrated in FIG. 1, the multi-layer coating arrangement 101/102 includes one or more top coating layers 101 that are or include one or more strain-tolerant DVC coatings. In example embodiments, the one or more top coating layers 101 are provided on an underlying combination of an EBC layer 102 and a CMC substrate 104. The one or more top coating layers 101 may include one or more DVC layers 101, and may be composed of ZrO₂ or HfO₂ stabilized with a rare earth oxide (RE₂O₃) mixed with a CMAS-resistant chemical composition. In example embodiments, the one or more top coating layers 101 may provide erosion and water vapor corrosion resistance. In further example embodiments, one of the one or more top coating layers 101 is deposited directly on the EBC layer 102. In other example embodiments, the one or more DVC layers 101 has a sufficient strain-tolerant microstructure that can tolerate large amount of expansion and/or contraction during thermal cycling.

In example embodiments, the one or more top coating layers 101 may be composed of RE-stabilized ZrO₂ or RE-stabilized HfO₂ mixed with CMAS-resistant chemistry to improve the erosion- and CMAS-resistance of the EBC/CMC 102/104 combination.

Example embodiments of the one or more top coating layers 101, with the DVC being erosion, water vapor corrosion-, and CMAS-resistant, include the following (with exemplary rare earth oxides including Yttrium Oxide, Lanthanum Oxide, Cerium Oxide, Praseodymium Oxide, Neodymium Oxide, Samarium Oxide, Europium Oxide, Gadolinium Oxide, Terbium Oxide, Dysprosium Oxide, Holmium Oxide, Erbium Oxide, Ytterbium Oxide, Lutetium Oxide, Scandium Oxide, Thulium Oxide):

RE-stabilized ZrO₂ or RE-stabilized HfO₂; or

RE-stabilized ZrO₂ or RE-stabilized HfO₂ mixture with Rare earth oxides; or

RE-stabilized ZrO₂ or RE-stabilized HfO₂ mixture with Rare earth Silicate; or

RE-stabilized ZrO₂ or RE-stabilized HfO₂ mixture with Rare earth Aluminate; or

RE-stabilized ZrO₂ or RE-stabilized HfO₂ mixture with Rare earth Aluminate Silicate; or

RE-stabilized ZrO₂ or RE-stabilized HfO₂ mixture with alkaline oxides; or

RE-stabilized ZrO₂ or RE-stabilized HfO₂ mixture with Gadolinium Zirconate; or

Rare earth silicates; or

Any combination of the above.

In example embodiments, the one or more RE-stabilized may have a CTE of 10×10⁻⁶/° C., as well as a thickness of between 2 mils and 40 mils. The one or more RE-stabilized may be applied by atmospheric plasma spraying (APS), plasma spray physical vapor deposition (PS-PVD), or suspension plasma spray (SPS).

In example embodiments, the EBC layer 102 may include one or more EBC layer(s) or coating 102, and may have a CTE of 3.5-7×10⁻⁶/° C., as well as a thickness of between 1 mil and 40 mils. This EBC layer 102 may be applied by a plurality of methods such as, e.g., atmospheric plasma spraying (APS), plasma spray physical vapor deposition (PS-PVD), or suspension plasma spray (SPS).

In example embodiments, one or more bond coating layers 103 may be provided between the EBC layer 102 and the CMC substrate 104. In other example embodiments, the one or more bond coating layers 103 may be or include Si, Silicide, Si—HfO₂, and/or Si-RE, and may have a CTE of 3.5-6×10⁻⁶/° C., as well as a thickness of between 0 mils (no bond coating layer) and 10 mils. The one or more bond coating layers 103 may be applied via a plurality of methods such as, e.g., atmospheric plasma spraying (APS), plasma spray physical vapor deposition (PVD), or suspension plasma spray (SPS).

In example embodiments, the CMC substrate 104 may have a CTE of ˜4.5-5.5×10⁻⁶/° C., as well as a thickness of greater than 40 mils. The CMC substrate may be or include SiC or Si₃N₄.

In example embodiments, the porosity of the one or more top coating layers 101 may be less than 5%, and the cracks may extend either partially through the thickness of the top coating layers 101, i.e., less than 50% of the thickness, or about 50% of the thickness of the thickness of the top coating layers 101, and may extend through an entire thickness of the top coating layers 101. In other example embodiments, the cracks may be substantially vertical cracks and may range in density between 20 and 200 cracks per inch.

### EXAMPLES

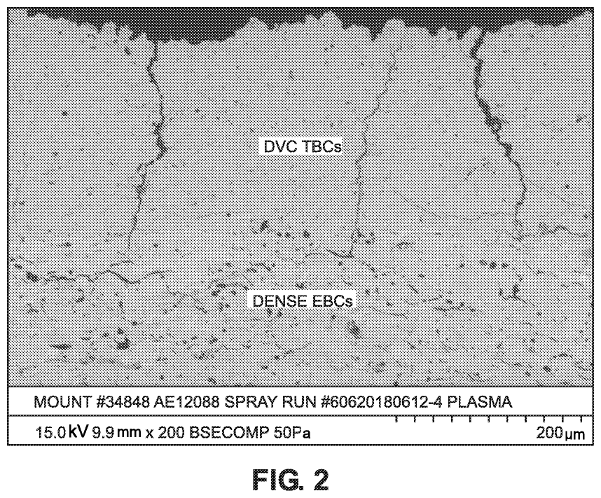

FIG. 2 shows a scanning electron microscope (SEM) cross-section of an applied multi-layer coating in accordance with example embodiments. In FIG. 2, the topcoat DVC layer also includes a thermal barrier coating (TBC), and is deposited directly onto the dense EBC. FIG. 2 illustrates the cracks that extend vertically form the outside surface of the DVC inwards.

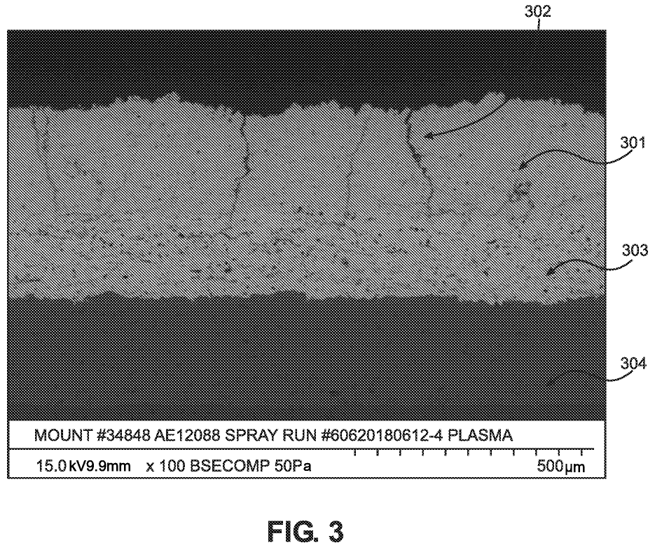

FIG. 3 shows a scanning electron microscope (SEM) cross-section of an applied multi-layer coating that was subjected to testing, in accordance with example embodiments. In FIG. 3, the top DVC layer 301 includes vertically oriented cracks 302, and is coated on the EBC 303. In example embodiments, the EBC 303 is coated on a substrate 304 such as, e.g., a CMC.

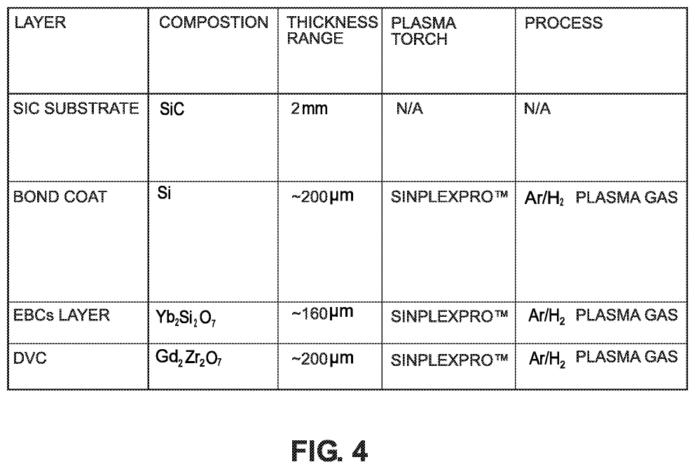

FIG. 4 describes the coating system used in the coating layer of FIG. 3. In FIG. 4, the substrate is SiC and has a thickness of about 2 mm, a bond coat is present and is a Si layer with a thickness of about 200 μm, the EBC layer is Yb₂Si₂O₇ with a thickness of about 160 μm, and the DVC is Gd₂Zr₂O₇ with a thickness of about 200 μm. In example embodiments, the process used to form the above coatings is an Ar/H₂ plasma gas.

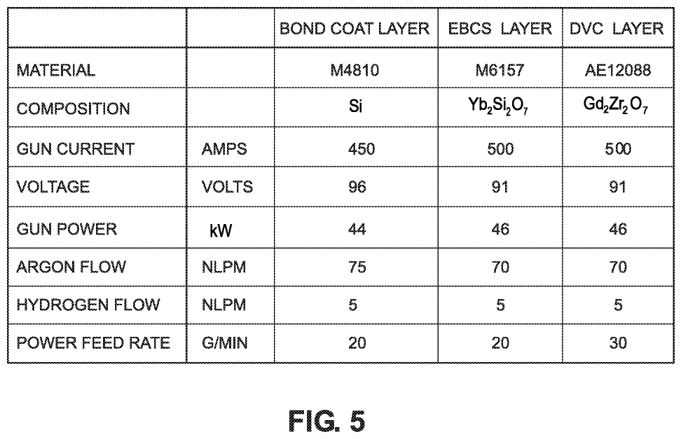

FIG. 5 describes the atmospheric plasma spraying (APS) parameters used to spray the coating system of FIG. 4. In example embodiments, the APS parameters for the bond coat layer include a gun current of 450 amps, a voltage of 90 volts, a gun power of 44 kW, an Argon flow of 75 nlpm (normal liter per minute), a hydrogen flow of 5 nlpm, and a powder feed rate of 20 g/min. In example embodiments, the APS parameters for the EBC layer include a gun current of 500 amps, a voltage of 91 volts, a gun power of 46 kW, an Argon flow of 70 nlpm, a hydrogen flow of 5 nlpm, and a powder feed rate of 20 g/min. In example embodiments, the APS parameters for the deposition of the DVC layer include a gun current of 500 amps, a voltage of 91 volts, a gun power of 46 kW, an Argon flow of 70 nlpm, a hydrogen flow of 5 nlpm, and a powder feed rate of 30 g/min.

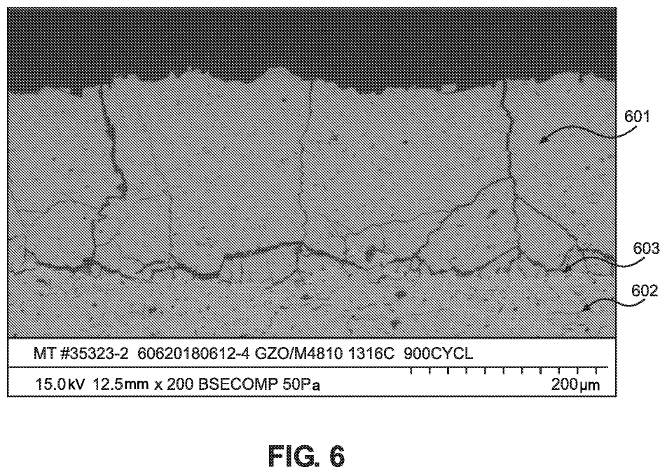

FIG. 6 illustrates the coating of FIG. 3 after having undergone a 900-plus cycle test, and illustrates the coating microstructure having a separation between the DVC top layer 601 and the EBC 602 at interface 603 after 900 cycles at a temperature of 1316° C. The furnace cycle test (FCT) protocol used is as follows: the samples are heated up from room temperature to 1316° C. in 10 minutes, maintained at this 1316° C. temperature for 40 minutes, and then cooled to room temperature in 10 minutes. After 900 cycles, the coating did not exhibit spall. However, the cross section illustrated in FIG. 6 shows that the topcoat (DVC) started to delaminate but did not spall. As such, the sample underwent 900 cycles or more without exhibiting spall.

The following patent and publications includes references that are incorporated herein in their entirety by reference: U.S. Pat. Nos. 8,197,950; 5,073,433; US 2014/0178632; U.S. Pat. Nos. 5,830,586; 6,703,137; 6,177,200; 7,875,370; US 2012/0034491; U.S. Pat. Nos. 9,023,486; US 2016/0348226; U.S. Pat. Nos. 6,296,941; 6,284,325; 6,387,456; 6,733,908; 7,740,960; US 2010/0158680; U.S. Pat. No. 7,910,172; US 2016/0215631; US 2016/0017749; US 2014/0272197; US 2014/0065438; US 2014/0272197; and US 2013/0344319.

Further, at least because the invention is disclosed herein in a manner that enables one to make and use the same, by virtue of the disclosure of particular exemplary embodiments, such as for simplicity or efficiency, for example, the invention may be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A multi-layer coating arrangement comprising:
an environmental barrier coating (EBC) over a substrate; and
at least one dense vertically cracked (DVC) coating layer over the EBC, the at least one DVC layer being resistant to at least one of erosion, water vapor corrosion, and calcium-magnesium-aluminum-silicate (CMAS).

2. The coating of claim 1, wherein the at least one DVC layer is a top layer.

3. The coating of claim 1, further comprising at least one bond coating layer between the EBC and the substrate.

4. The coating of claim 1, wherein the substrate comprises a ceramic matrix composite (CMC).

5. The coating of claim 1, wherein the at least one DVC coating layer comprises RE-stabilized ZrO₂ or RE-stabilized HfO₂.

6. The coating of claim 1, wherein the at least one DVC coating layer comprises RE-stabilized ZrO₂ mixed with a rare earth oxide, or comprises RE-stabilized HfO₂ mixed with a rare earth oxide.

7. The coating of claim 1, wherein the at least one DVC coating layer comprises RE-stabilized ZrO₂ mixed with a rare earth silicate, or comprises RE-stabilized HfO₂ mixed with a rare earth silicate.

8. The coating of claim 1, wherein the at least one DVC coating layer comprises RE-stabilized ZrO₂ mixed with a rare earth aluminate, or comprises RE-stabilized HfO₂ mixed with a rare earth aluminate.

9. The coating of claim 1, wherein the at least one DVC coating layer comprises RE-stabilized ZrO₂ mixed with a rare earth aluminate or silicate, or comprises RE-stabilized HfO₂ mixed with a rare earth aluminate or silicate.

10. The coating of claim 1, wherein the at least one DVC coating layer comprises RE-stabilized ZrO₂ mixed with an alkaline oxide, or comprises RE-stabilized HfO₂ mixed with an alkaline oxide.

11. The coating of claim 1, wherein the at least one DVC coating layer comprises RE-stabilized ZrO₂ mixed with a gadolinium zirconate, or comprises RE-stabilized HfO₂ mixed with a gadolinium zirconate.

12. The coating of claim 1, wherein the at least one DVC coating layer comprises rare earth silicates.

13. The coating of claim 1, wherein the at least one DVC coating layer comprises a mixture of two or more of:
RE-stabilized ZrO₂ or RE-stabilized HfO₂;
RE-stabilized ZrO₂ mixed with a rare earth oxide, or RE-stabilized HfO₂ mixed with a rare earth oxide;
RE-stabilized ZrO₂ mixed with a rare earth silicate, or RE-stabilized HfO₂ mixed with a rare earth silicate;
RE-stabilized ZrO₂ mixed with a rare earth aluminate, or RE-stabilized HfO₂ mixed with a rare earth aluminate;
RE-stabilized ZrO₂ mixed with a rare earth aluminate or silicate, or RE-stabilized HfO₂ mixed with a rare earth aluminate or silicate;
RE-stabilized ZrO₂ mixed with an alkaline oxide, or RE-stabilized HfO₂ mixed with an alkaline oxide;
RE-stabilized ZrO₂ mixed with a gadolinium zirconate, or RE-stabilized HfO₂ mixed with a gadolinium zirconate; and
Rare earth silicates.

14. The coating of claim 1, wherein the at least one DVC coating layer comprises full thickness vertical cracks.

15.-26. (canceled)

27. A method of forming a coating that is resistant to erosion, water vapor corrosion and to CMAS on a substrate coated with at least one EBC coating layer, the method comprising:
plasma spraying a DVC coating material over the at least one EBC coating layer.

28. The method of claim 27, wherein the coating further comprises at least one bond coating layer between the at least one EBC coating layer and the substrate.

29. The method of claim 27, wherein the plasma spraying comprises one of:
atmospheric plasma spraying (APS);
physical vapor deposition (PS-PVD); and
suspension plasma spray (SPS).

30.-31. (canceled)

32. The coating of claim 1, wherein no CTE-mitigating layer is present between the DVC layer and the EBC.

33. The coating of claim 1, wherein no porous vertically cracked (PVC) intermediate layer is present between the DVC layer and the EBC.
